(19) United States
(12) Patent Application Publication
(10) Pub. No.: US 2026/0056104 A1
(43) Pub. Date: Feb. 26, 2026

(54) ACCELERATED WEAR DEVICE FOR CERAMIC TILE AND WEAR TEST METHOD THEREOF

(71) Applicants: DONGGUAN CITY WONDERFUL CERAMICS INDUSTRIAL PARK CO., LTD., Dongguan (CN); MARCOPOLO HOLDINGS CO., LTD., Dongguan (CN)

(72) Inventors: Zhanhao CHEN, Dongguan (CN); Zhengqiang SHENG, Dongguan (CN); Jiaqi HUANG, Dongguan (CN); Zhanwen GU, Dongguan (CN); Kehui LIN, Dongguan (CN); Yongqiang WANG, Dongguan (CN); Zhongmin LI, Dongguan (CN); Xuebin LIU, Dongguan (CN); Duanxu CAO, Dongguan (CN); Daocong HUANG, Dongguan (CN); Hanling YANG, Dongguan (CN)

(73) Assignees: DONGGUAN CITY WONDERFUL CERAMICS INDUSTRIAL PARK CO., LTD., Dongguan (CN); MARCOPOLO HOLDINGS CO., LTD., Dongguan (CN)

(21) Appl. No.: 18/931,960

(22) Filed: Oct. 30, 2024

(30) Foreign Application Priority Data
Aug. 23, 2024 (CN) 202411165430.9

(51) Int. Cl. G01N 3/56; G01N 3/02

(52) U.S. Cl. CPC G01N 3/56; G01N 3/02; G01N 2203/005

(57) ABSTRACT

An accelerated wear device for a ceramic tile and a wear test method thereof. The accelerated wear device includes an X-axis drive mechanism; a Z-axis drive mechanism, disposed on the X-axis drive mechanism; a rotary friction mechanism, disposed on the Z-axis drive mechanism; and an abrasive tool seat, disposed on the rotary friction mechanism, where the abrasive tool seat is used for mounting a wearing part, and drives the wearing part to perform a friction motion with a to-be-tested ceramic tile under the drive of the X-axis drive mechanism, the Z-axis drive mechanism and the rotary friction mechanism.

### CROSS-REFERENCE TO RELATED APPLICATIONS

The application claims priority of Chinese patent application No. 202411165430.9, filed on Aug. 23, 2024, which is incorporated herein by reference in its entireties.

### TECHNICAL FIELD

The present disclosure relates to the field of ceramic tiles, and in particular to an accelerated wear device for a ceramic tile and a wear test method thereof.

### BACKGROUND

Architectural ceramic tiles are mainly used for walls and floors of home spaces, and have the function of easy cleaning and beautiful decoration. However, with the improvement of people's living standards, higher requirements on the function of the ceramic tiles have been put forward, particularly the anti-slip performances of the ceramic tiles.

The relatively high anti-slip performances of the floor ceramic tiles are required for some decorative spaces. The anti-slip tile in the market has many types, and can be classified into a mold anti-slip tile, a glaze anti-slip tile, a dry grain anti-slip tile and a post-processing anti-slip tile according to the technology mode. To improve the anti-slip performance of the product, manufacturing enterprises often compound and superpose multiple technologies for improving the anti-slip performance of the ceramic tile, to improve the anti-slip performance of the ceramic tile from many perspectives and many aspects. For example, uneven molds are combined with the anti-slip glaze and anti-slip dry grains, and some manufacturing enterprises adopt the combination of the anti-slip glaze with later anti-slip liquid, the combination of the uneven molds with the anti-slip liquid, the combinations of the mold surfaces with a later processing broach, and other methods; and the whole anti-slip performance of the ceramic tile is improved through the superposition of the anti-slip technologies.

But, no matter which process technology is used to improve the anti-slip function of the ceramic tile, the surface of the ceramic tile will have a certain degree of wear after the anti-slip ceramic tile is used for a period of time, and in particular the wear in entrances and exits of public places and other areas is more severe. The anti-slip ceramic tile product will be affected to some extent in the anti-slip function after being used for a period of time, even some ceramic tiles adopting the anti-slip technology have very high original anti-slip safety performance, but the anti-slip function disappears after a short period of application and wear, which seriously affects consumers' credibility to the anti-slip ceramic tile, and also brings potential safety hazards to the consumers, thus affecting the promotion and use of the anti-slip ceramic tile to some extent.

At present, a device capable of rapidly wearing the anti-slip ceramic tile is not available in the architectural ceramics industry, thus not determining the anti-slip performance of the used ceramic tile.

Therefore, the prior art exists defects, and needs to be improved and developed.

### SUMMARY

The technical problem to be solved by the present disclosure lies in providing an accelerated wear device for a ceramic tile and a wear test method thereof in view of the above defects in the prior art, so as to solve the problem that a device capable of rapidly wearing an anti-slip ceramic tile is not available in the prior art, thus not determining the anti-slip performance of the used ceramic tile.

The technical solution adopted to solve the technical problem in the present disclosure is as follows:

Embodiments in a first aspect of the present disclosure provide an accelerated wear device for a ceramic tile, including:
an X-axis drive mechanism;
a Z-axis drive mechanism, disposed on the X-axis drive mechanism;
a rotary friction mechanism, disposed on the Z-axis drive mechanism; and
an abrasive tool seat, disposed on the rotary friction mechanism, where the abrasive tool seat is used for mounting a wearing part, and drives the wearing part to perform a friction motion with a to-be-tested ceramic tile under the drive of the X-axis drive mechanism, Z-axis drive mechanism and rotary friction mechanism.

In one embodiment of the present disclosure, the accelerated wear device further includes a linear mechanism fixed frame and a linear mechanism back plate disposed on the linear mechanism fixed frame, and the X-axis drive mechanism is disposed on the linear mechanism back plate;
the X-axis drive mechanism includes:
a single-axis linear drive member, fixed to the linear mechanism back plate;
a vertical mechanism back plate, slidingly connected to the single-axis linear drive member;
a tow chain fastener, fixed to the vertical mechanism back plate; and
a tow chain, where one end of the tow chain is fixed to the single-axis linear drive member while the other end is connected with the tow chain fastener, and the tow chain is fitted in parallel to the single-axis linear drive member, to guide the tow chain fastener.

In one embodiment of the present disclosure, the Z-axis drive mechanism includes:
a motor base, fixed to one side of the vertical mechanism back plate that deviates from the single-axis linear drive member;
a stepping motor, fixed to the motor base;
a ball screw, connected with an output shaft of the stepping motor;
a lead screw nut bracket, sleeved on the ball screw; and
a rotary mechanism back plate, fixedly connected with the lead screw nut bracket.

In one embodiment of the present disclosure, the Z-axis drive mechanism further includes:
a first coupling, through which the ball screw is connected with the output shaft of the stepping motor;
a fixed-side bearing seat and a supported-side bearing seat, both of which are disposed on the vertical mechanism back plate; and
where the ball screw includes a fixed side and a supported side, the fixed-side bearing seat is used for supporting the fixed side of the ball screw, and the supported-side bearing seat is used for supporting the supported side of the ball screw.

In one embodiment of the present disclosure, the Z-axis drive mechanism further includes:
linear guide rails, fixed to one side of the vertical mechanism back plate that deviates from the single-axis linear drive member;
linear sliders, disposed on the linear guide rail and connected with the rotary mechanism back plate; and
where the linear guide rails are set in parallel to the ball screw.

In one embodiment of the present disclosure, two linear guide rails are provided and located on both sides of the ball screw in respective, two linear sliders are disposed on each linear guide rail, and various linear sliders are all connected with the rotary mechanism back plate.

In one embodiment of the present disclosure, the rotary friction mechanism includes:
a motor fixed seat, disposed on the rotary mechanism back plate;
a brushless motor, disposed on the motor fixed seat;
a rotating shaft, connected with an output shaft of the brushless motor; and
an abrasive tool seat connector, disposed at one end of the rotating shaft that deviates from the brushless motor, used for connecting the abrasive tool seat.

In one embodiment of the present disclosure, the rotary mechanism back plate is also provided with a pressure sensor fixed frame, on which a pressure sensor is disposed, and the pressure sensor is used for detecting the pressure of the to-be-tested ceramic tile.

In one embodiment of the present disclosure, the accelerated wear device further includes a device base, the linear mechanism fixed frame is erected on the device base, an upper end face of the device base is also provided with a ceramic tile fixed area, and the ceramic tile fixed area is located below the rotary friction mechanism to fix the to-be-tested ceramic tile.

Embodiments in a second aspect of the present disclosure provide a wear test method achieved on the basis of the above accelerated wear device for the ceramic tile, including:
mounting a wearing part on an abrasive tool seat, and fixing a to-be-tested ceramic tile below the wearing part;
driving a rotary friction mechanism to move downward by using a Z-axis drive mechanism, the Z-axis drive mechanism continuing to drive the rotary friction mechanism to move downward until to reach a preset pressure when the wearing part on the abrasive tool seat is in contact with an upper surface of the to-be-tested ceramic tile; and
driving the Z-axis drive mechanism and the rotary friction mechanism to perform a reciprocating motion by using an X-axis drive mechanism, making the wearing part on the abrasive tool seat and the to-be-tested ceramic tile perform a friction motion.

The present disclosure provides an accelerated wear device for a ceramic tile and a wear test method thereof. The accelerated wear device includes an X-axis drive mechanism; a Z-axis drive mechanism, disposed on the X-axis drive mechanism; a rotary friction mechanism, disposed on the Z-axis drive mechanism; and an abrasive tool seat, disposed on the rotary friction mechanism, where the abrasive tool seat is used for mounting a wearing part, and drives the wearing part to perform a friction motion with a to-be-tested ceramic tile under the drive of the X-axis drive mechanism, Z-axis drive mechanism and rotary friction mechanism. In the present disclosure, arranging the X-axis drive mechanism, Z-axis drive mechanism, rotary friction mechanism and abrasive tool seat enables the abrasive tool seat to drive the wearing part to perform the friction motion with the to-be-tested ceramic tile under the drive of the X-axis drive mechanism, Z-axis drive mechanism and rotary friction mechanism, thus achieving the rapid wear of the to-be-tested ceramic tile, and then determining the anti-slip performance of the worn ceramic tile.

### BRIEF DESCRIPTION OF THE DRAWINGS

FIG. 1 is a schematic structural diagram of a preferred embodiment according to an accelerated wear device for a ceramic tile in the present disclosure.

FIG. 2 is a cooperation schematic diagram of an X-axis drive mechanism, a Z-axis drive mechanism and a rotary friction mechanism of a preferred embodiment according to an accelerated wear device for a ceramic tile in the present disclosure.

FIG. 3 is a structural exploded diagram of a preferred embodiment in a first perspective according to an accelerated wear device for a ceramic tile in the present disclosure.

FIG. 4 is a structural exploded diagram of a preferred embodiment in a second perspective according to an accelerated wear device for a ceramic tile in the present disclosure.

FIG. 5 is a complete assembly schematic diagram of a preferred embodiment according to an accelerated wear device for a ceramic tile in the present disclosure.

### REFERENCE SIGNS

100. X-axis drive mechanism, 110. Single-axis linear drive member, 120. Vertical mechanism back plate, 130. Tow chain fastener, 140. Tow chain, 200. Z-axis drive mechanism, 210. Motor base, 220. Stepping motor, 230. Ball screw, 240. Lead screw nut bracket, 250. Rotary mechanism back plate, 260. First coupling, 270. Fixed-side bearing seat, 280. Supported-side bearing seat, 290. Linear guide rail, 291. Linear slider, 300. Rotary friction mechanism, 310. Motor fixed seat, 320. Brushless motor, 330. Abrasive tool seat connector, 340. Second coupling, 350. Spindle bearing fixed seat, 360. Spindle bearing, 370. Precise locking nut, 400. Abrasive tool seat, 410. Wearing part, 500. To-be-tested ceramic tile, 600. Linear mechanism fixed frame, 610. Linear mechanism back plate, 700. Pressure sensor fixed frame, 710. Pressure sensor, 800. Device base, 810. Outer cover, 820. Protective cover.

### DETAILED DESCRIPTION OF THE EMBODIMENTS

In order to make the objectives, technical solution and advantages of the present disclosure clearer and definer, the embodiments of the present disclosure will be described in detail below in conjunction with the drawings. It is understood that the specific embodiments described herein are merely used for explaining the present disclosure, instead of limiting the present disclosure.

In the prior art, after used in the practical space for a period of time, the ant-slip ceramic tile is not tested in advance whether to remain the anti-slip performance continuously, thus not determining the anti-slip safety of the worn anti-slip tile. Currently, the technology, device and test method capable of rapidly acquiring the wear of the anti-slip tile are not yet available in the architectural ceramics industry. Both the wear-resisting grade and wear volume currently adopted in the prior art cannot simulate the practical application situation well, the wear-resisting grade determination has great relations with the product color, the wear material used by the wear volume is also not in line with the practical life, and after the wear test, the change of the surface part of the ceramic tile before and after the wear cannot also be tested accurately by the existing anti-slip detection method, thus not determining the anti-slip performance after wearing.

In view of the deficiencies in the above prior art, the present disclosure provides an accelerated wear device for a ceramic tile, the device can exert pressure on the surface of the anti-slip ceramic tile and perform the accelerated wear back and forth, to simulate the using effect of the practical scenes of life; the surface of the worn anti-slip ceramic tile can be suitable for various test methods for the existing anti-slip ceramic tile, and therefore the anti-slip performance of the anti-slip ceramic tile after long-term application can be foreknown in advance.

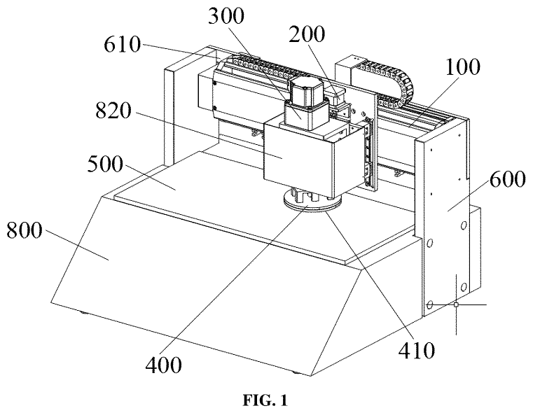

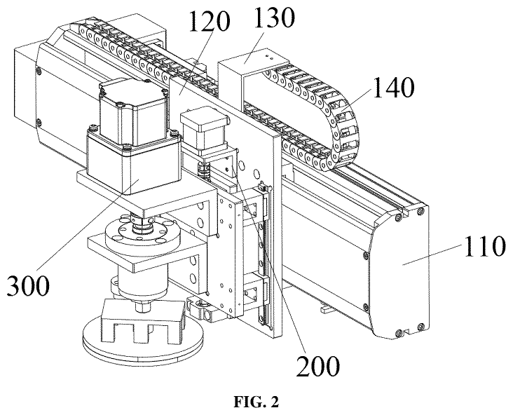

As shown in FIG. 1 and FIG. 2, the accelerated wear device for the ceramic tile provided by present disclosure includes: an X-axis drive mechanism 100, a Z-axis drive mechanism 200, a rotary friction mechanism 300 and an abrasive tool seat 400. The Z-axis drive mechanism 200 is disposed on the X-axis drive mechanism 100, the rotary friction mechanism 300 is disposed on the Z-axis drive mechanism 200, and the abrasive tool seat 400 is disposed on the rotary friction mechanism 300. The abrasive tool seat 400 is used for mounting a wearing part 410, and drives the wearing part 410 to perform a friction motion with a to-be-tested ceramic tile 500 under the drive of the X-axis drive mechanism 100, Z-axis drive mechanism 200 and rotary friction mechanism 300.

In embodiments of the present disclosure, arranging the X-axis drive mechanism 100, Z-axis drive mechanism 200, rotary friction mechanism 300 and abrasive tool seat 400 enables the abrasive tool seat 400 to drive the wearing part 410 to perform the friction motion with the to-be-tested ceramic tile 500 under the drive of the X-axis drive mechanism 100, Z-axis drive mechanism 200 and rotary friction mechanism 300, thus achieving the rapid wear of the to-be-tested ceramic tile 500, and then determining the anti-slip performance of the worn ceramic tile.

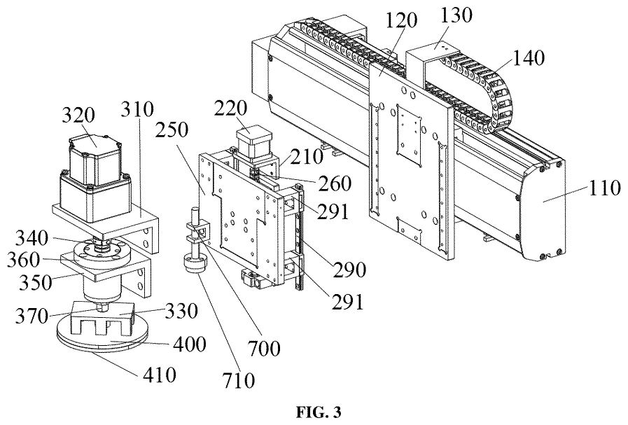

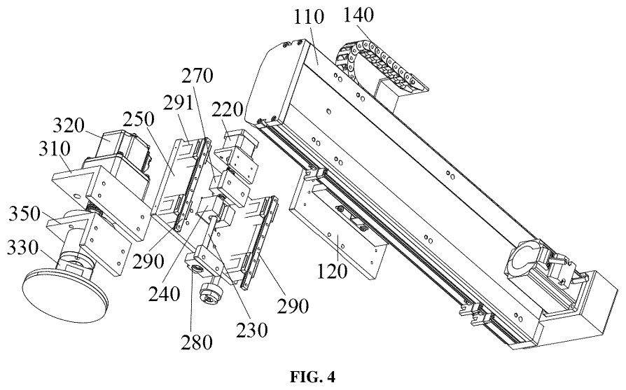

In one embodiment of the present disclosure, the accelerated wear device further includes a linear mechanism fixed frame 600 and a linear mechanism back plate 610 disposed on the linear mechanism fixed frame 600, and the X-axis drive mechanism 100 is disposed on the linear mechanism back plate 610. As shown in FIG. 3 and FIG. 4, the X-axis drive mechanism 100 includes a single-axis linear drive member 110, a vertical mechanism back plate 120, a tow chain fastener 130 and a tow chain 140. The single-axis linear drive member 110 is fixed to the linear mechanism back plate 610, the vertical mechanism back plate 120 is slidingly connected to the single-axis linear drive member 110, the tow chain fastener 130 is fixed to the vertical mechanism back plate 120; and one end of the tow chain 140 is fixed to the single-axis linear drive member 110 while the other end is connected with the tow chain fastener 130, and the tow chain 140 is fitted in parallel to the single-axis linear drive member 110, to guide the tow chain fastener 130.

Specifically, the single-axis linear drive member 110 has a drive motor, and the tow chain 140 has a guide effect. The X-axis drive mechanism 100 provided by embodiments of the present disclosure has a high transmission efficiency, and can reduce the energy loss and improve the whole efficiency of mechanical equipment.

In one embodiment of the present disclosure, the Z-axis drive mechanism 200 includes a motor base 210, a stepping motor 220, a ball screw 230, a lead screw nut bracket 240 and a rotary mechanism back plate 250. The motor base 210 is fixed to one side of the vertical mechanism back plate 120 that deviates from the single-axis linear drive member 110, the stepping motor 220 is fixed to the motor base 210, the ball screw 230 is connected with an output shaft of the stepping motor 220, the lead screw nut bracket 240 is sleeved on the ball screw 230, and the rotary mechanism back plate 250 is fixedly connected with the lead screw nut bracket 240.

Specifically, the stepping motor 220 provides a rotary motion that is transferred to the ball screw 230, and when the ball screw 230 rotates, the rotary monition of the ball screw 230 is converted into a linear motion of a nut. Therefore, the ball screw 230 achieves the conversion from the rotary motion to the linear motion, and can perform high-speed forward and reverse transmission steadily and improve the motion stability of the accelerated wear device in a Z-axis direction.

In one embodiment of the present disclosure, the Z-axis drive mechanism 200 further includes a first coupling 260, a fixed-side bearing seat 270 and a supported-side bearing seat 280. The ball screw 230 is connected with the output shaft of the stepping motor 220 through the first coupling 260, and both the fixed-side bearing seat 270 and the supported-side bearing seat 280 are disposed on the vertical mechanism back plate 120. The ball screw 230 includes a fixed side and a supported side, the fixed-side bearing seat 270 is used for supporting the fixed side of the ball screw, and the supported-side bearing seat 280 is used for supporting the supported side of the ball screw.

Specifically, the vertical mechanism back plate 120 may also be provided with base plates of the fixed-side bearing seat 270 and the supported-side bearing seat 280, the fixed-side bearing seat 270 is disposed on the base plate of the fixed-side bearing seat 270, and the supported-side bearing seat 280 is disposed on the base plate of the supported-side bearing seat 280.

The coupling is a component through which the output shaft of the motor is connected with the ball screw 230, and mainly functions in transferring the rotary motion of the motor to the ball screw 230, thus achieving the rotation of the ball screw 230; and moreover the coupling can absorb an axis deviation (such as eccentricity, deflection and axial displacement) between rotating bodies, which helps reduce the vibration and noise caused by mounting or manufacturing errors, and improves the system stability and reliability.

The bearing seat is a component for mounting the bearing of the ball screw 230, and provides stable supporting and accurate positioning, to ensure that the ball screw 230 remains the accurate axis direction during rotation; and moreover, the bearing seat can bear various loads generated by the ball screw 230 during transmission. A bearing seat base plate can be disposed on the vertical mechanism back plate 120, such that the bearing seat is fixed to the bearing seat base plate.

In one embodiment of the present disclosure, the Z-axis drive mechanism 200 further includes a linear guide rail 290 and a linear slider 291. The linear guide rail 290 is fixed to one side of the vertical mechanism back plate 120 that deviates from the single-axis linear drive member 110; the linear slider 291 is disposed on the linear guide rail 290 and connected with the rotary mechanism back plate 250, and the linear guide rail 290 is set in parallel to the ball screw 230.

Specifically, the linear guide rail 290 may also be provided with a linear slider 291 gasket, and the linear slider 291 is disposed on the linear slider 291 gasket. Since both the ball screw 230 and the linear guide rail 290 have the characteristic of high precision, the ball screw 230 achieves the high-efficiency transmission through ball rolling and has the high precision and high load capacity, the linear guide rail 290 provides the accurate guidance for the linear motion, and the cooperative use of the ball screw 230 and the linear guide rail 290 in embodiments of the present disclosure can further improve the whole positioning precision of the device. Moreover, the linear guide rail 290 provides the stable support to the ball screw 230, which helps reduce the vibration and deflection of the screw during transmission, and under a working condition of high speed or high load, the linear guide rail 290 can remain better dynamic response and rigidity, to ensure the stable motion without fluctuation of the ball screw 230. The linear guide rail 290 can also bear some axial and radial loads generated by the ball screw 230 during transmission, thus easing the burden of the screw and prolonging the service life thereof.

In one embodiment of the present disclosure, two linear guide rails 290 are provided and located on both sides of the ball screw 230 in respective, two linear sliders 291 are disposed on each linear guide rail 290, and various linear sliders 291 are all connected with the rotary mechanism back plate 250.

In embodiments of the present disclosure, the linear guide rails 290 are disposed on both sides of the ball screw 230, which can significantly improve the positioning precision, stability, bearing capacity and motion control efficiency of the device.

In one embodiment of the present disclosure, the rotary friction mechanism 300 includes a motor fixed seat 310, a brushless motor 320, a rotating shaft and an abrasive tool seat connector 330. The motor fixed seat 310 is disposed on the rotary mechanism back plate 250, the brushless motor 320 is disposed on the motor fixed seat 310, and the rotating shaft is connected with an output shaft of the brushless motor 320; and the abrasive tool seat connector 330 is disposed at one end of the rotating shaft that deviates from the brushless motor 320, and the abrasive tool seat connector 330 is used for connecting the abrasive tool seat 400.

Specifically, an output shaft of the brushless motor 320 is connected with the rotating shaft by adopting a second coupling 340. The rotary mechanism back plate 250 is also provided with a spindle bearing fixed seat 350, and a spindle bearing 360 is fixed to the spindle bearing fixed seat 350. The bearing mainly functions in reducing the friction between rotating components, making the rotating shaft rotate more smoothly, thus reducing the energy consumption and improving the operating efficiency of the mechanical equipment. The rotating sleeve is also sleeved with a precise locking nut 370, the precise locking nut 370 can effectively fix the rotating shaft, bearing and other components, to ensure that these components will not be loosened or fall during rotation, thus improving the operating safety and reliability of the mechanical equipment.

In one embodiment of the present disclosure, the rotary mechanism back plate 250 is also provided with a pressure sensor fixed frame 700, on which a pressure sensor 710 is disposed, and the pressure sensor 710 is used for detecting the pressure of the to-be-tested ceramic tile 500.

Specifically, the pressure sensor fixed frame 700 includes a pressure sensor 710 fixed seat disposed on the rotary mechanism back plate 250 and a pressure sensor 710 fixed rod disposed on the pressure sensor 710 fixed seat, the pressure sensor 710 is disposed on the pressure sensor 710 fixed seat, and a clamping gear may be set between the fixed rod and the fixed seat. Thus, both the pressure sensor 710 and the wearing part 410 provided with the friction material can be in contact with the tile surface, the Z-axis drive mechanism 200 moves downward slowly such that the friction material and the pressure sensor 710 generate a certain pressure to the tile, the numerical value of the pressure sensor 710 is recorded, and the pressure sensor 710 is lifted. For example, the pressure sensor 710 is lifted to the previous gear.

In embodiments of the present disclosure, the degree of wear caused to the tile surface when the same person treads and rubs the tile surface for many times is simulated by changing the number of reciprocating and rotating speed of the device in a case that the pressure of the wear material to the tile surface is fixed by arranging the pressure sensor 710, and the degree of wear on the surface of the to-be-tested object can be rapidly simulated through pressure regulation.

In one embodiment of the present disclosure, the accelerated wear device further includes a device base 800, the linear mechanism fixed frame 600 is erected on the device base 800, an upper end face of the device base 800 is also provided with a ceramic tile fixed area, and the ceramic tile fixed area is located below the rotary friction mechanism 300 to fix the to-be-tested ceramic tile 500.

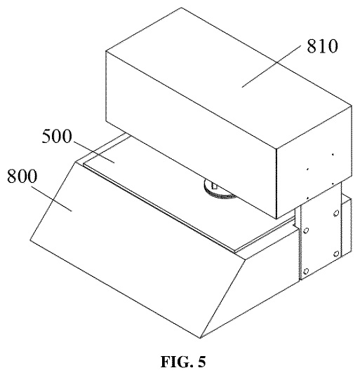

Specifically, four corners of the device base 800 that are in contact with the floor are provided with floor mats, which helps improve the whole stability of the device. In addition, as shown in FIG. 5, in embodiments of the present disclosure, an outer cover 810 and a protective cover 820 are disposed above the device base 800, making the device more safe and beautiful.

In embodiments of the present disclosure, the surface of the anti-slip ceramic tile can be worn rapidly in advance, to form an equivalent wear state in the practical application, thus foreknowing whether the anti-slip ceramic tile still has the anti-slip performance after being used for a period of time, moreover, the the surface of the tile can be subjected to the accelerated wear in a more scientific, effective and datamation manner, and in particular the surface of the anti-slip ceramic tile is subjected to the equivalent wear test, to solve the problem that the anti-slip performance of the used anti-slip ceramic tile cannot be determined rapidly at present.

The present disclosure has achieved the following beneficial effects:

First, the accelerated wear device provided by the present disclosure can wear the tile surface rapidly and more completely, adjust wear parameters in multiple dimensions, and improve the device safety.

Second, the accelerated wear device provided by the present disclosure can achieve the rapid wear on the surface of the to-be-tested object, without waiting for the long time of test data in the practical application scenarios, thus obtaining the wear effect rapidly.

Third, the accelerated wear device provided by the present disclosure is flexible in test, can perform the reciprocating linear wear motion alone, and also achieve the simultaneous wear of the circumferential wear motion and the linear wear motion in combination with a disk, to quicken the wear efficiency.

Embodiments of the present disclosure provide a wear test method achieved on the basis of the above accelerated wear device for the ceramic tile, including:
mounting a wearing part 410 on an abrasive tool seat 400, and fixing a to-be-tested ceramic tile 500 below the wearing part 410;
driving a rotary friction mechanism 300 to move downward by using a Z-axis drive mechanism 200, the Z-axis drive mechanism 200 continuing to drive the rotary friction mechanism 300 to move downward until to reach a preset pressure when the wearing part 410 on the abrasive tool seat 400 is in contact with an upper surface of the to-be-tested ceramic tile 500; and
driving the Z-axis drive mechanism 200 and the rotary friction mechanism 300 to perform a reciprocating motion by using an X-axis drive mechanism 100, making the wearing part 410 on the abrasive tool seat 400 and the to-be-tested ceramic tile 500 perform a friction motion.

Specifically, the rapid wear device is adjusted, to make the device base 800 in a horizontal state, during initial use, the wear material needs to be mounted on the wearing part 410, and during continuous use, the wear material needs to be checked whether to be replaced; and the to-be-tested ceramic tile 500 is mounted and fixed, and the ceramic tile is checked whether to be mounted steadily and horizontally. The contact surface of the pressure sensor 710 and the contact surface of the wearing part 410 are adjusted to the same height, the Z-axis drive mechanism 200 runs, such that both the pressure sensor 710 and the wearing part 410 provided with the wear material can be in contact with the tile surface, the Z-axis drive mechanism 200 moves downward slowly such that the friction material and the pressure sensor 710 generate a certain pressure to the tile, at this time the numerical value of the pressure sensor 710 is recorded, and the pressure sensor 710 is lifted.

The device can also set the number of the rapid wear, 100 times are set first according to a sequence from low to large, then when the wear is tested continuously, the required number of wear is added to the previous number of wear in turn.

In addition, according to the practical test requirements, whether or not the wearing part 410 needs to rotate can be selected in embodiments of the present disclosure. When the rotation is selected, the rotating speed needs to be set first, the rotary friction material is selected; and when the rotation is not selected, the rectangular friction material is selected.

After the device is started, the X-axis drive mechanism 100 runs, the device wears the surface of the to-be-tested ceramic tile 500 rapidly and automatically according to the set parameters until a counter displays zero, then the wear ends.

In one embodiment, the device parameters include an appearance parameter, a running parameter, an adjustable parameter, a wearing part 410 size, a wearing part 410 material, and a settable parameter. The appearance parameter may be 675 mm in length, 635 mm in width and 520 mm in height; the running parameter may be an X-axis stroke of 350 mm and a Z-axis stroke of 21 mm; the settable parameter may be a rotating shaft speed of 0-3,000 r/min and a pressure scope of 0 kg-10 kg; the wearing part 410 size includes a circular wearing part 410 and a rectangular wearing part 410, and the circular wearing part 410 has a diameter of 125 mm+1 mm; and the rectangular wearing part 410 may be a wear cleaning cloth with an area of (50 mm±1 mm)×(125 mm±1 mm), and a sliding area of (125 mm±1 mm)×(300 mm±1 mm). The material of the wearing part 410 may be a 3M gray 7448Pro universal scouring pad; when the number of the reciprocating wear of the wear material reaches 20,000, the rapid wear material of the same model shall be used; and the new rapid wear material can be used for the test after being subjected to 50 times of reciprocating wear on the dried testing surface. The settable parameter includes: 1. X-axis reciprocating frequency: 0-9,999, 2. Tile height (thickness): 0-21 mm, 3. Pressure scope: 0-10 kg; and 4. Rotating speed of the wearing part 410: 0-3,000 r/min.

The wearing part 410 in embodiments of the present disclosure is more in line with the the vamp wear material when people walk on the floor in the practical application scenarios, and the surface of the worn ceramic tile can be suitable for methods and determination standards for testing various existing anti-slip tiles.

The present disclosure provides an accelerated wear device for a ceramic tile and a wear test method thereof. The accelerated wear device includes an X-axis drive mechanism; a Z-axis drive mechanism, disposed on the X-axis drive mechanism; a rotary friction mechanism, disposed on the Z-axis drive mechanism; and an abrasive tool seat, disposed on the rotary friction mechanism, where the abrasive tool seat is used for mounting a wearing part, and drives the wearing part to perform a friction motion with a to-be-tested ceramic tile under the drive of the X-axis drive mechanism, Z-axis drive mechanism and rotary friction mechanism. In the present disclosure, arranging the X-axis drive mechanism, Z-axis drive mechanism, rotary friction mechanism and abrasive tool seat enables the abrasive tool seat to drive the wearing part to perform the friction motion with the to-be-tested ceramic tile under the drive of the X-axis drive mechanism, Z-axis drive mechanism and rotary friction mechanism, thus achieving the rapid wear of the to-be-tested ceramic tile, and then determining the anti-slip performance of the worn ceramic tile.

It is understood that the application of the present disclosure is not limited to the above examples, those of ordinary skill in the art can make improvements or changes according to the above specification. However, these improvements or changes fall in the protection scope of the claims of the present disclosure.

What is claimed is:

1. An accelerated wear device for a ceramic tile, comprising:
an X-axis drive mechanism;
a Z-axis drive mechanism disposed on the X-axis drive mechanism;
a rotary friction mechanism disposed on the Z-axis drive mechanism; and
an abrasive tool seat, disposed on the rotary friction mechanism, wherein the abrasive tool seat is used for mounting a wearing part, and drives the wearing part to perform a friction motion with a to-be-tested ceramic tile under the drive of the X-axis drive mechanism, Z-axis drive mechanism and rotary friction mechanism.

2. The accelerated wear device for the ceramic tile according to claim 1, wherein the accelerated wear device further comprises a linear mechanism fixed frame and a linear mechanism back plate disposed on the linear mechanism fixed frame, and the X-axis drive mechanism is disposed on the linear mechanism back plate;
the X-axis drive mechanism comprises:
a single-axis linear drive member fixed to the linear mechanism back plate;
a vertical mechanism back plate slidingly connected to the single-axis linear drive member;
a tow chain fastener fixed to the vertical mechanism back plate; and
a tow chain, wherein one end of the tow chain is fixed to the single-axis linear drive member while the other end is connected with the tow chain fastener, and the tow chain is fitted in parallel to the single-axis linear drive member, to guide the tow chain fastener.

3. The accelerated wear device for the ceramic tile according to claim 2, wherein the Z-axis drive mechanism comprises:
a motor base fixed to one side of the vertical mechanism back plate that deviates from the single-axis linear drive member;
a stepping motor fixed to the motor base;
a ball screw connected with an output shaft of the stepping motor;
a lead screw nut bracket sleeved on the ball screw; and
a rotary mechanism back plate fixedly connected with the lead screw nut bracket.

4. The accelerated wear device for the ceramic tile according to claim 3, wherein the Z-axis drive mechanism further comprises:
a first coupling, through which the ball screw is connected with the output shaft of the stepping motor; and
a fixed-side bearing seat and a supported-side bearing seat, both of which are disposed on the vertical mechanism back plate;
wherein the ball screw comprises a fixed side and a supported side, the fixed-side bearing seat is used for supporting the fixed side of the ball screw, and the supported-side bearing seat is used for supporting the supported side of the ball screw.

5. The accelerated wear device for the ceramic tile according to claim 3, wherein the Z-axis drive mechanism further comprises:
linear guide rails fixed to one side of the vertical mechanism back plate that deviates from the single-axis linear drive member; and
linear sliders disposed on the linear guide rail and connected with the rotary mechanism back plate;
wherein the linear guide rails are set in parallel to the ball screw.

6. The accelerated wear device for the ceramic tile according to claim 5, wherein two linear guide rails are provided and located on both sides of the ball screw in respective, two linear sliders are disposed on each linear guide rail, and various linear sliders are all connected with the rotary mechanism back plate.

7. The accelerated wear device for the ceramic tile according to claim 3, wherein the rotary friction mechanism comprises:
a motor fixed seat disposed on the rotary mechanism back plate;
a brushless motor disposed on the motor fixed seat;
a rotating shaft connected with an output shaft of the brushless motor; and
an abrasive tool seat connector disposed at one end of the rotating shaft that deviates from the brushless motor, and used for connecting the abrasive tool seat.

8. The accelerated wear device for the ceramic tile according to claim 7, wherein the rotary mechanism back plate is also provided with a pressure sensor fixed frame, on which a pressure sensor is disposed, and the pressure sensor is used for detecting the pressure of the to-be-tested ceramic tile.

9. The accelerated wear device for the ceramic tile according to claim 2, wherein the accelerated wear device further comprises a device base, the linear mechanism fixed frame is erected on the device base, an upper end face of the device base is also provided with a ceramic tile fixed area, and the ceramic tile fixed area is located below the rotary friction mechanism to fix the to-be-tested ceramic tile.

10. A wear test method achieved on the basis of the accelerated wear device for the ceramic tile according to claim 1, comprising:
mounting a wearing part on an abrasive tool seat, and fixing a to-be-tested ceramic tile below the wearing part;
driving a rotary friction mechanism to move downward by using a Z-axis drive mechanism, the Z-axis drive mechanism continuing to drive the rotary friction mechanism to move downward until to reach a preset pressure when the wearing part on the abrasive tool seat is in contact with an upper surface of the to-be-tested ceramic tile; and
driving the Z-axis drive mechanism and the rotary friction mechanism to perform a reciprocating motion by using an X-axis drive mechanism, making the wearing part on the abrasive tool seat and the to-be-tested ceramic tile perform a friction motion.
